(19) United States
(12) Patent Application Publication
(10) Pub. No.: US 2011/0025519 A1
(43) Pub. Date: Feb. 3, 2011

(54) NON-INTRUSIVE UTILITY MONITORING

(75) Inventors: James Donaldson, Oxford (GB); Chris Shelley, Great Bealings (GB); Chris Lemondine Martin, Debenham (GB); Malcolm McCulloch, Oxford (GB); Sarah Surrall, Oxford (GB); Alex Matthews, Oxford (GB); Semen Trygubenko, Oxford (GB)

Correspondence Address: Ostrow Kaufman LLP;Susan Formicola, The Chrysler Building, 405 Lexington Avenue, 62nd Floor, NEW YORK, NY, 10174, US

(73) Assignee: INTELLIGENT SUSTAINABLE ENERGY LIMITED, Oxford (GB)

(21) Appl. No.: 12/728,436

(22) Filed: Mar. 22, 2010

(30) Foreign Application Priority Data
Jul. 30, 2009 (GB) 0913312.5
Jan. 15, 2010 (GB) 1000695.5

(51) Int. Cl. G08B 21/00; G06N 7/02; G06F 1/26

(52) U.S. Cl. 340/664; 706/52; 700/295

(57) ABSTRACT

A method of outputting to a user an indication of the usage of a utility, the method comprising: obtaining data indicating, for each of a plurality of appliances, a respective current level of usage of the utility by that appliance; for each of a plurality of appliance categories, using the obtained data to calculate a respective current total level of usage of the utility by appliances belonging to that appliance category; and outputting an indication of the calculated current total level of usage of the utility for at least one of the plurality of appliance categories.

### FIELD OF THE INVENTION

The present invention relates to a method and system for outputting an indication of the usage of a utility. The present invention also relates to a user interface for outputting an indication of the usage of a utility.

### BACKGROUND OF THE INVENTION

For both cost and environmental reasons, consumers are under increasing pressure to reduce the consumption of utilities such as electricity, water, gas and oil.

There have been a number of recent technology innovations in this area. Devices such as The OWL (see http://www.theowl.com/index.php?page=about-owl) display the current electricity consumption of a residence on a local display. Another supplier of such systems is Green Energy Options (see http://www.greenenergyoptions.co.uk/product_range/home_energy_hub/). These systems typically display the energy consumed by an entire house in a simple manner.

There also exists a class of energy monitor termed NILM or NIALM—non intrusive appliance load monitors. Like ‘The Owl’, these monitors measure the total energy consumed by the house at a single point, but these monitors additionally use advanced algorithms to break down the total energy consumption into individual energy consumptions for each household appliance.

A significant challenge in such a system is designing a display that effectively communicates the key information to the consumer in such a way as to help them achieve energy savings, without hiding the information in a confusing interface, or overloading the non-technical consumer with too much information. The present invention seeks to address this challenge.

### SUMMARY OF THE INVENTION

According to a first aspect of the invention, there is provided a method of outputting to a user an indication of the usage of a utility, the method comprising: obtaining data indicating, for each of a plurality of appliances, a respective current level of usage of the utility by that appliance; for each of a plurality of appliance categories, using the obtained data to calculate a respective current total level of usage of the utility by appliances belonging to that appliance category; and outputting an indication of the calculated current total level of usage of the utility for at least one of the plurality of appliance categories.

In one embodiment, the method comprises allowing a user to select an appliance category from the plurality of appliance categories, wherein said outputting comprises outputting an indication of the calculated current total level of usage of the utility for the selected appliance category.

In one embodiment, the method comprises using the obtained data to calculate a current total level of usage of the utility by the plurality of appliances; and outputting an indication of the calculated current total level of usage of the utility by the plurality of appliances.

In one embodiment, said outputting comprises displaying on a display an indication of the calculated current total level of usage of the utility for the at least one of the plurality of appliance categories.

In one embodiment, the method comprises: for each appliance category, displaying an associated icon to represent the appliance category; wherein said outputting comprises setting a colour of an icon to indicate the calculated current total level of usage of the utility for the appliance category associated with that icon. Setting a colour of an icon may comprise selecting a colour for the icon from a predetermined set of colours, wherein each colour in the predetermined set of colours represents an associated range of levels of usage of the utility. In one embodiment, the method comprises, for at least one of the colours in the predetermined set of colours, adjusting the associated range of levels of usage of the utility based on an input from the user.

In one embodiment, said outputting comprises indicating, on a scale with colour-coding, the calculated current total level of usage of the utility for the at least one of the plurality of appliance categories. In one embodiment, the method further comprising adjusting the colour-coding of the scale based on an input from the user.

In one embodiment, said outputting comprises displaying a numerical value indicating the calculated current total level of usage of the utility for the at least one of the plurality of appliance categories.

In one embodiment, the method comprises: using the obtained data to calculate a level of usage of the utility by the plurality of appliances over a period of time; outputting an indication of the calculated level of usage of the utility by the plurality of appliances over the period of time.

In one embodiment, the method comprises, for at least one of the plurality of appliance categories: using the obtained data to calculate a level of usage of the utility by appliances belonging to that appliance category over a period of time; outputting an indication of the calculated level of usage of the utility by appliances belonging to that appliance category over the period of time.

In one embodiment, the method comprises allowing a user to specify which of the plurality of appliances belong to a particular appliance category.

In one embodiment, the method comprises dynamically determining the appliance categories.

In one embodiment, said outputting comprises annunciating an indication of the calculated current total level of usage of the utility for the at least one of the plurality of appliance categories.

In one embodiment, said obtaining comprises measuring the current total use of the utility by the plurality of appliances to obtain utility usage values; and analysing the utility usage values to identify which of the plurality of appliances is using the utility and to calculate the current level of usage of the utility by an identified appliance.

According to another aspect of the invention, there is provided a system comprising: a processor arranged to: obtain data indicating, for each of a plurality of appliances, a respective current level of usage of the utility by that appliance; and for each of a plurality of appliance categories, use the obtained data to calculate a respective current total level of usage of the utility by appliances belonging to that appliance category; and an interface arranged to output an indication of the calculated current total level of usage of the utility for at least one of the plurality of appliance categories.

In one embodiment, the system comprises an input arranged to allow a user to select an appliance category from the plurality of appliance categories, wherein said interface is arranged to output an indication of the calculated current total level of usage of the utility for the selected appliance category.

In one embodiment, the processor is arranged to use the obtained data to calculate a current total level of usage of the utility by the plurality of appliances; and wherein the interface is arranged to output an indication of the calculated current total level of usage of the utility by the plurality of appliances.

In one embodiment, the said interface comprises a display for displaying an indication of the calculated current total level of usage of the utility for the at least one of the plurality of appliance categories.

In one embodiment, the said interface is arranged, for each appliance category, to display an associated icon to represent the appliance category, and to set a colour of an icon to indicate the calculated current total level of usage of the utility for the appliance category associated with that icon. Said interface may be arranged to set a colour of an icon by selecting a colour for the icon from a predetermined set of colours, wherein each colour in the predetermined set of colours represents an associated range of levels of usage of the utility. In one embodiment, said interface is arranged, for at least one of the colours in the predetermined set of colours, to adjust the associated range of levels of usage of the utility based on an input from the user.

In one embodiment, said interface is arranged to indicate, on a scale with colour-coding, the calculated current total level of usage of the utility for the at least one of the plurality of appliance categories. Said interface may be arranged to adjust the colour-coding of the scale based on an input from the user.

In one embodiment, said interface is arranged to display a numerical value indicating the calculated current total level of usage of the utility for the at least one of the plurality of appliance categories.

In one embodiment, the processor is arranged to use the obtained data to calculate a level of usage of the utility by the plurality of appliances over a period of time, and wherein the interface is arranged to output an indication of the calculated level of usage of the utility by the plurality of appliances over the period of time.

In one embodiment, for at least one of the plurality of appliance categories, the processor is arranged to use the obtained data to calculate a level of usage of the utility by appliances belonging to that appliance category over a period of time, and wherein the interface is arranged to output an indication of the calculated level of usage of the utility by appliances belonging to that appliance category over the period of time.

In one embodiment, the system is arranged to allow a user to specify which of the plurality of appliances belong to a particular appliance category.

In one embodiment, the processor is arranged to dynamically determine the appliance categories.

In one embodiment, the said interface is arranged to annunciate an indication of the calculated current total level of usage of the utility for the at least one of the plurality of appliance categories.

In one embodiment, the said system is arranged to: measure the current total use of the utility by the plurality of appliances to obtain utility usage values; and analyse the utility usage values to identify which of the plurality of appliances is using the utility and to calculate the current level of usage of the utility by an identified appliance.

In one embodiment, the said interface is arranged to output said indication of the calculated current total level of usage of the utility for at least one of the plurality of appliance categories to a user terminal.

According to an aspect of the invention, there is provided a user interface arranged to output to a user an indication of a current total level of usage of a utility by a subset of appliances from a plurality of appliances.

According to an aspect of the invention, there is provided a computer readable medium storing a computer program which, when executed by a processor, carries out the steps of: obtaining data indicating, for each of a plurality of appliances, a respective current level of usage of the utility by that appliance; for each of a plurality of appliance categories, using the obtained data to calculate a respective current total level of usage of the utility by appliances belonging to that appliance category; and outputting an indication of the calculated current total level of usage of the utility for at least one of the plurality of appliance categories.

According to an aspect of the invention there is provided a method of non-intrusive utility monitoring for monitoring the use of at least one utility supplied to a plurality of appliances, the method comprising: receiving utility values representative of the total use of the at least one utility by the plurality of appliances; analysing the received utility values using a plurality of analysis modules, wherein each analysis module corresponds to a respective predetermined type of utility usage, and wherein each analysis module is arranged to calculate, based on the received utility values, a respective confidence value indicative of a confidence that the respective predetermined type of utility usage has occurred; and performing a fuzzy logic analysis of the calculated confidence values so as to identify the operation of an appliance.

In one embodiment, the predetermined type of utility usage for one of the plurality of analysis modules is usage representative of a resistive device with a relatively constant steady-state load.

In one embodiment, the predetermined type of utility usage for one of the plurality of analysis modules is usage representative of a predominantly resistive device employing intra-cycle switching to variably control the power supplied to a load.

In one embodiment, the predetermined type of utility usage for one of the plurality of analysis modules is usage representative of an induction motor wherein a path traced by real power values against corresponding reactive power values over a time period of interest comprises one or more substantially circular arcs.

In one embodiment, the at least one utility comprises electricity, and the utility values comprise values representative of the electrical current and/or the electrical voltage supplied to the plurality of appliances.

In one embodiment, the at least one utility comprises one or more of water, gas and oil.

In one embodiment, the method furthers comprise detecting at least one utility event based on the received utility values.

In one embodiment, each confidence value is a degree of membership of a respective membership function corresponding to the respective predetermined type of utility usage.

According to an aspect of the invention, there is provided a computer readable medium storing a computer program which, when executed by a processor, carries out a method of non-intrusive utility monitoring for monitoring the use of at least one utility supplied to a plurality of appliances by carrying out the steps of: receiving utility values representative of the total use of the at least one utility by the plurality of appliances; analysing the received utility values using a plurality of analysis modules, wherein each analysis module corresponds to a respective predetermined type of utility usage, and wherein each analysis module is arranged to calculate, based on the received utility values, a respective confidence value indicative of a confidence that the respective predetermined type of utility usage has occurred; and performing a fuzzy logic analysis of the calculated confidence values so as to identify the operation of an appliance.

According to an aspect of the invention, there is provided a non-intrusive utility monitoring apparatus for monitoring the use of at least one utility supplied to a plurality of appliances, the apparatus comprising: an input section arranged to receive utility values representative of the total use of the at least one utility by the plurality of appliances; a plurality of analysis modules, wherein each analysis module corresponds to a respective type of utility usage, and wherein each analysis module is arranged to analyse the received utility values so as to calculate, based on the received utility values, a respective confidence value indicative of a confidence that the respective type of utility usage has occurred; and a fuzzy logic module arranged to perform a fuzzy logic analysis of the calculated confidence values so as to identify the operation of an appliance.

In one embodiment, the apparatus further comprises a processor which comprises the plurality of analysis modules and the fuzzy logic module.

### BRIEF DESCRIPTION OF THE DRAWINGS

Embodiments of the invention will now be described, by way of example only, with reference to the accompanying drawings, in which:

FIG. 1 depicts schematically a Non-Intrusive Utility Monitoring (NIUM) system using a NIUM apparatus according to one embodiment of the invention;

FIG. 2 depicts schematically the NIUM apparatus of FIG. 1;

FIG. 3 shows the Fourier domain representation of the current waveform from a single appliance;

FIG. 4 shows a typical current waveform for a TRIAC-type device;

FIG. 5 shows an example of a membership function for a resistive analysis module of the NIUM apparatus of FIGS. 1 and 2;

FIG. 6 depicts schematically one embodiment of a fuzzy logic module of the NIUM apparatus of FIGS. 1 and 2;

FIG. 7 shows a display window for displaying utility usage information to a user;

FIG. 8 is an exploded pie chart showing electricity usage for various electrical appliances;

FIG. 9 is an exploded pie chart showing the same electricity usage information as the pie chart of FIG. 8, except that the electrical appliances have been grouped into appliance categories in the pie chart of FIG. 9;

FIG. 10 shows the display window of FIG. 7 with the “water heating” appliance category selected such that utility usage information relevant to that category is additionally displayed;

FIG. 11 is a flow chart illustrating a method of dynamically categorising appliances into appliance categories;

FIG. 12 is an exploded pie chart showing the same electricity usage information as the pie charts of FIGS. 8 and 9, following application of the dynamic appliance categorisation method shown in FIG. 11; and

FIG. 13 shows the display window of FIG. 10 with “savings mode” activated to show a target 20% saving.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

### (1) A NIUM System

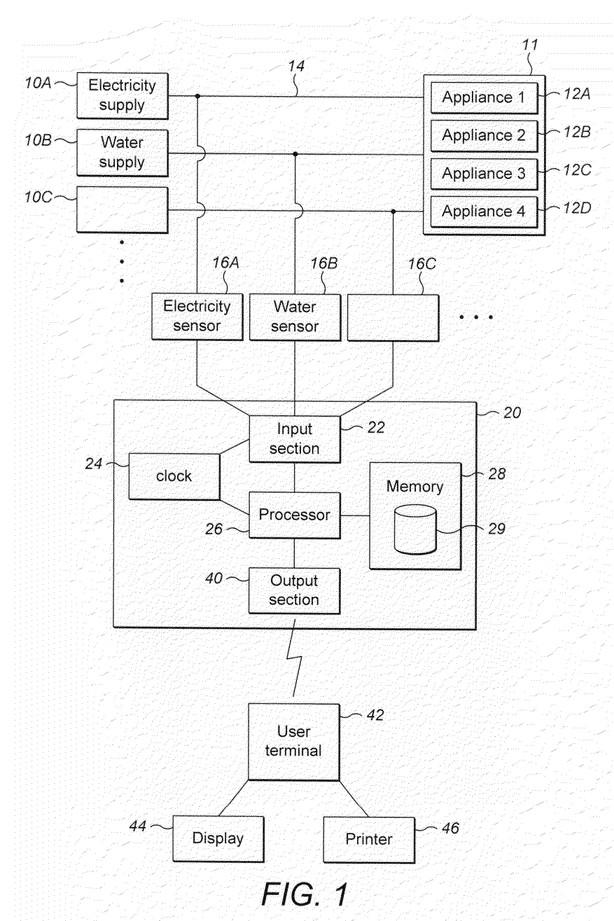

An overview of a Non-Intrusive Utility Monitoring (NIUM) system is shown in FIG. 1. This NIUM system has previously been described in UK Patent Application No. 1000695.5 (the contents of which are incorporated herein by reference).

In FIG. 1, the electricity supply to a site (e.g. a house, apartment, office, shop, school, building, etc.) is denoted 10A. The electricity is supplied to one or more of a plurality of appliances 12A, 12B, 12C, 12D . . . by means of conventional wiring 14. The appliances and wiring are simply shown schematically in FIG. 1, but may, of course, be configured in any appropriate way, such as via a consumer unit with circuit breakers or fuses, and with one or more ring main circuits with branches or spurs. An electricity meter 16A is provided to measure the total instantaneous current being provided to all of the appliances 12 from the supply 10A, and also to measure the instantaneous voltage of the electricity supply 10A. The current is measured by any suitable sensor, for example a current clamp placed around one of the conductors of the electricity supply wiring 14. The current clamp typically comprises a magnetizable material, such as ferrite, which forms a magnetic circuit around the conductor, and acts as a transformer to induce a voltage in a secondary winding around the magnetizable material, from which the current flowing in the supply wiring 14 can be obtained. As an alternative to this current-transformer, a Hall-effect sensor can be used to measure the magnetic field in the loop of magnetizable material around the wire which is related to the current flowing through the wire. Other suitable ways may, of course, be used for sensing the current.

The voltage of the electricity supply can also be measured by any suitable volt meter. This, of course, typically requires access to two of the conductors in the wiring 14. This can be achieved, for example, by probes which strap around the respective cables and have spikes which penetrate the insulation to make contact with the conductor. Alternatively, connections could be made to terminals in the consumer unit, or, for example, at a location where fuses or circuit breakers are insertable. Non-invasive capacitive voltage detectors could also be used.

In FIG. 1, some appliances 12 (e.g. washing machine or power-shower) are also connected to the water supply 10B. Alternatively, some appliances (e.g. kitchen sink tap) may only be connected to the water supply 10B and not the electricity supply 10A. A water meter 16B detects the flow of water. Some appliances 12 may additionally/alternatively be connected to the supply of other utilities 10C, 10D, . . . . Corresponding utility meters 16C, 16D, . . . are provided to detect the overall utility usage of each utility 10C, 10D, . . . by the appliances 12 at the site 11. It will be appreciated that different embodiments may make relate to some or all of the utility supplies 10A, 10B, 10C—e.g. some may relate to only monitoring/analysing electricity supply values, some may relate to only monitoring/analysing water supply values, some may relate to only monitoring/analysing gas supply values, whilst some may relate to monitoring/analysing supply values of different combinations of utilities.

As shown in FIG. 1, the utility meters 16 are connected to an NIUM apparatus 20. It is, of course, possible that some or all of the utility meters 16 are incorporated within the apparatus 20, for example that wires connect the supply wiring 14 to the apparatus 20, and the voltage is measured within the apparatus 20. Alternatively, in a different embodiment, the one or more of the utility meters 16 may be self-contained and may communicate with the apparatus 20 wirelessly, e.g. by sending analogue or digital values of the instantaneous current and instantaneous voltage. In one option, the apparatus 20 can derive its own power supply by virtue of being connected to the portion of the electricity meter 16A for measuring voltage. In one particular form of this, the apparatus 20 is simply plugged into an electrical outlet in the same way as an appliance 12 to obtain its power supply and also to measure the supply voltage. However, in the preferred embodiment, the apparatus 20 and utility meters 16 are conveniently located near where the utility supplies 10 enters the building 11, such as near where the conventional electricity meter is or would be located.

The apparatus 20 comprises a number of different units, namely an input section 22, a clock 24, a processor 26, a store or memory 28, and an output section 40. It is possible to implement each of the various units as dedicated hard-wired electronic circuits; however the various units do not have to be separate from each other, and could all be integrated onto a single electronic chip such as an Application Specific Integrated Circuit (ASIC) or Field Programmable Gate Array (FPGA) or Digital Signal Processor (DSP) device. Furthermore, the units can be embodied as a combination of hardware and software, and the software can be executed by any suitable general-purpose microprocessor, such that in one embodiment the apparatus 20 could be a conventional personal computer (PC). The software would take the form of one or more computer programs having computer instructions which, when executed by a computer (e.g. processor 26) carry out a method according to an embodiment of the present invention as discussed below. The computer programs may be stored on a computer-readable storage medium, such as a magnetic disc, optical disc (e.g. a CD or DVD), etc.

The input section 22 of the apparatus 20 receives current and voltage values from the electricity meter 16A. The values are input or measured preferably multiple times per cycle of the alternating electricity supply to a level of accuracy as required by the application. If the values are supplied as analogue voltages, then the input section 22 may comprise, for example, an analogue to digital converter, such that the rest of the apparatus 20 can be implemented using digital electronics. The input section 22 of the apparatus 20 also receives values representative of use of water (e.g. water flow rate measurements or water pressure measurements) from the water meter 16B. Similarly, other values may be provided to the input section 22 by the other utility meters 16C, 16D, . . . (e.g. other utility flow rate measurements such as oil or gas flow rate measurements, or other utility pressure measurements such as oil or gas pressure measurements). The input section 22 also receives time data from the clock 24 which provides the actual present time. The clock 24 could, of course, be integral with other components of the apparatus 20, or the apparatus 20 could receive a clock signal from an external source such as a transmitter broadcasting time data. In one preferred embodiment the clock 24 comprises a quartz oscillator together with other timer circuitry that is an integral part of the processor 26 (described below). In this case, the input section 22 for receiving the time data is also an integral part of the processor 26. The processor performs a number of different functions, as described below, that may be referred to by names of items; in the preferred embodiment of the invention, these items are implemented as software modules.

The memory 28 stores a database 29 of information/data regarding various known appliances. The power consumption of some appliances is variable. For example, a washing machine will consume considerably different amounts of power during different portions of a washing program/cycle and this will differ from program to program. All such data is retained in the memory 28 for each known appliance. The memory 28 may be any suitable computer-readable storage medium, such as a solid-state computer memory, a hard drive, or a removable disc-shaped medium in which information is stored magnetically, optically or magneto-optically. The memory 28, may even be remote from the apparatus and accessible, for example, via a telephone line or over the internet. The memory 28 may be dynamically updateable, for example by downloading new appliance data. This could be done via the supply wiring 14 itself or, in one optional version, the memory 28 is provided as an IC-card insertable by the user into a slot in the apparatus 20. Manufacturers of appliances provide the necessary appliance data either directly to the consumer, or to the utility company. New IC-cards can be mailed to the user to update their apparatus 20. The software that the processor 26 runs to perform the analysis may also be stored in the memory 28 and updated as desired in the same ways as the appliance data (e.g. by downloading, by inserting a new medium such as a disc or IC-card, and so on).

The processor 26 receives data from the input section 22, the memory 28 and possibly the clock 24. The processor could be a general purpose processing device or could be a digital signal processor or could be a bespoke hardware device (e.g. FPGA or ASIC) manufactured specifically for implementing one or more embodiments of the invention. The processor 26 then performs various processing/analysis steps which are described in detail below. Following the processing/analysis, the processor 26 produces information regarding electrical energy utilisation for some or all of the appliances 12. This information may be transmitted directly to the utility provider. Alternatively, this information may be output by the output section 40 to a user terminal 42 (such as a PC or a dedicated device for utility-use feedback) so that the information can be conveniently presented to the user. The user terminal 42 can be a standard desktop or laptop computer with an attached monitor/display 44 and/or printer 46, or can be a dedicated device. The user terminal 42 may comprise its own processor (not shown) for processing data (e.g. data received from the NIUM apparatus 20 and/or as an input from a user). Alternatively, the output section 40 may output the information directly to a person (e.g. visually when the output section 40 comprises a screen/display and/or audibly when the output section 40 comprises a speaker)—in this case the user terminal 42, display 44 and printer 46 may be omitted.

Although the apparatus 20 and the user terminal 42 are shown as separate devices in FIG. 1, they could, of course, be part of the same device. The output section 40 in the preferred embodiment communicates wirelessly, for example by radio frequencies (RF) link, or optically, or by infrared, or acoustically. However, it is also possible that the communication with the user terminal 42 is done through the supply wiring 14 if the user terminal 42 is plugged into one of the supply outlets as an appliance. In a further embodiment, the output section 40 can also act as a receiver, such that communication between the apparatus 20 and user terminal 42 is two-way. This enables the user terminal 42 to be used as a further means for updating the appliance data in the memory 28.

### (2) Processing Performed by the Processor 26 of the NIUM Apparatus 20

The voltage and current values and any other utility values together with the time data are received by the processor 26. From the raw data, the processor calculates a number of coefficients or signature values to characterise the present usage of each utility. Examples of coefficients or suitable signature values for electricity include, but are not limited to:

(a) the total real power consumption;

(b) the phase difference (angle) between the current and voltage which depends on the load applied by the various appliances 12 and whether it is purely resistive or also reactive, i.e. containing capacitive or inductive loads such as motors and transformers;

(c) the root-mean-squared (RMS) current.

Clearly some of the electricity coefficients or signature values mentioned above are averages, typically over a minimum of one cycle of the electricity supply, typically supplied at 50 or 60 hertz so one cycle is approximately 0.02 seconds. However, mean values of all of the various coefficients or signature values can be calculated over a longer predetermined time interval. The present values of the coefficients or signature values are compared with the running mean value of each coefficient or signature value over the previous cycle or cycles to obtain a change or ‘delta’ in each coefficient or signature value.

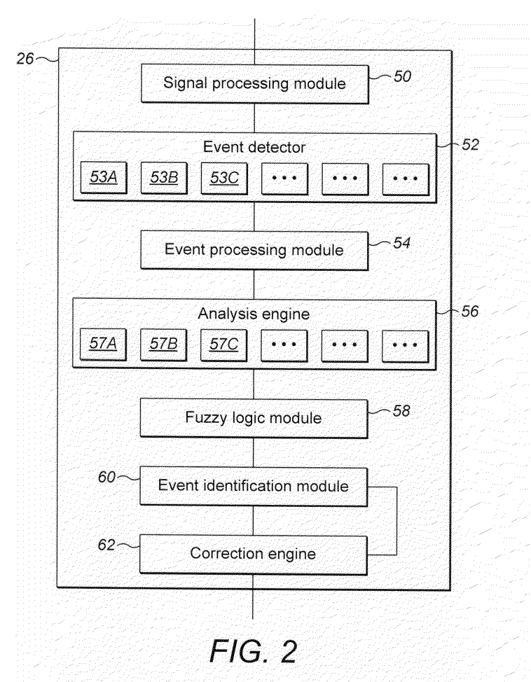

The processor 26 is shown in more detail in FIG. 2. In one embodiment, the processor 26 comprises, or is arranged to execute, a signal processing module 50, an event detector 52 comprising one or more detector modules 53A, 53B, 53C, . . . , an event processing module 54, an analysis engine 56 comprising one or more analysis modules 57A, 57B, 57C, . . . , a fuzzy logic module 58, an event identification module 60 and a correction engine 62.

The signal processing module 50 performs a number of functions and can be implemented in a combination of hardware of software. Some of these are standard such as anti-aliasing filtering and analog-to-digital conversion. However, a re-sampling system may also be included for higher accuracy.

Known event detectors relating to electrical events tend to look for a change in real power and possibly reactive power (e.g. see U.S. Pat. No. 4,858,141). The present apparatus 20 has an event detector 52 which includes one or more detector modules 53 that are used to detect utility ‘events’ relating to the use of one or more appliances 12 (as opposed to events which relate to random noise). Some event detectors may relate to only one utility, others may relate to combined utility events. The use of multiple detector modules 53 increases sensitivity and reduces the number of false positives. Thus, in a preferred embodiment, the present NIUM apparatus 20 uses a number of detector modules 53 operating in a parallel configuration.

One example of a detector module 53 is a standard electricity event detector module 53A. This is similar to known event detectors where a difference is calculated between the current electrical cycle and the average of the previous n cycles, where a suitable number for n may be 10. The background is averaged in order to reduce the effect of ‘noise’ spikes. If the difference is greater than a predetermined threshold, this indicates that an event of interest has occurred. Advantageously, the threshold is large (e.g. 400 W) in order to avoid noisy loads from triggering events.

Each detector module 53 of the event detector 52 feeds into the event processing module 54 which is configured to analyse the outputs of the detector modules 53. In a simplified example, each detector module 53 could comprise an output of 0 or 1. In this case, the most logical analysis paradigm is to OR the outputs together since each event detector is designed to detect a very specific feature to fully cover the input space whilst minimising the number of false positives. An alternate methodology would assign a score of between 0 and 1 from the output of each detector and then combine the results using the operations of Fuzzy Logic or Bayesian Inference.

The core of the NIUM apparatus 20 is contained in the analysis engine 56 which includes functional blocks referred to as analysis modules 57. Each analysis module corresponds to a respective predetermined type of utility usage (e.g. a TRIAC analysis module 57A is concerned with TRIAC-type electricity usage). Furthermore, each analysis module is arranged to calculate, based on received utility data, a respective confidence value indicative of a confidence that the respective predetermined type of utility usage (e.g. TRIAC-type electricity usage in the example above) has occurred. Many of the analysis modules 57 are non-trivial and act as time domain analysers.

Many of the analysis modules 57 work on high resolution time domain data. At its core, NIUM is a pattern recognition problem. Pattern recognition techniques often apply standard techniques (e.g. Fourier analysis) to transform the input space into a new space that is more easily analysable and suitable to the problem in hand. Fourier transforms are often used since they allow the extraction of characteristic periodic data that is not visible in time domain signal.

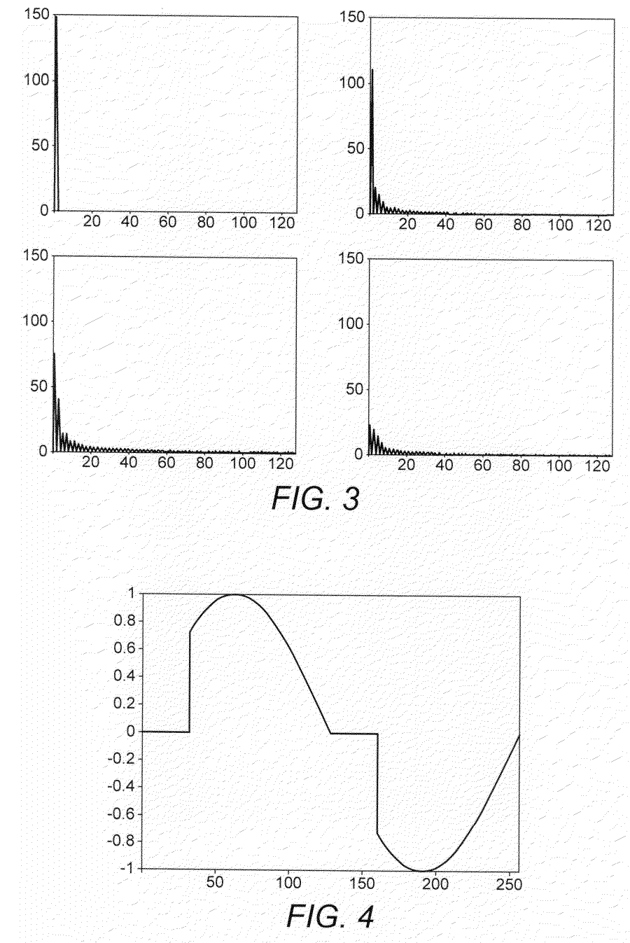

Outside of a few specific examples, the frequency spectrum does not form a useful basis set for the NIUM problem. This can be seen by considering the specific problem of detecting TRIAC lighting systems in their various modes of operation. FIG. 3 shows the Fourier domain representation of the current waveform and it can be seen that, despite the fact that this is all from a single appliance, there is no clear unique signature.

Therefore, in the present NIUM apparatus 20, the focus is on creating sets of features which enable a more computationally efficient and effective methodology.

The NIUM system described herein uses much higher electrical sampling rates (e.g. in the range of 8 kHz to 80 kHz) than the NILM systems of the prior art so as to extract a more useful set of features than those of the prior art (e.g. U.S. Pat. No. 4,858,141). By considering only power, it is hard to differentiate between a hypothetical 100 W heater and a 100 W motor or a 200 W lighting system which is at half power. By considering reactive power and harmonic spectra it is possible to gain a little more information; however whilst the harmonic spectrum does contain all of the information contained within the electrical waves, it does not transform the data into a set which is readily understandable.

The NIUM system described herein uses a number of analysis modules 57 which are well suited to identifying the characteristics of particular types of appliances, and thus can vastly improve the accuracy of appliance detection and energy monitoring. These analysis modules act in a variety of ways and a subset of the analysis modules used are described briefly below.

A TRIAC analysis module 57A uses a technique which can identify the characteristic waveform displayed by a variable brightness lighting system. The TRIAC analysis module 57A is fully described in UK Patent Application No. 0820812.6 and International Patent Application No. PCT/GB2009/001754 (the contents of both of which are incorporated herein by reference) and is briefly summarised here. A TRIAC is a semiconductor device which is used to control the power consumption of resistive devices. A typical TRIAC current waveform is shown in FIG. 4. It can be seen that the TRIAC only allows current to pass through the device for part of the cycle, with a sharp edge being present in the current waveform at the switch on/off. When it is non-conducting, the current passed is 0. In the TRIAC analysis module 57A, there is a monitor section, a delta waveform generator and an edge detector. The monitor section is arranged to determine current waveforms comprising sets of values representative of the cyclic waveform of the electric current supply. The delta waveform generator is arranged to calculate the difference between a current waveform and an earlier current waveform, by subtracting the respective sets of values determined by the monitor section, to obtain a delta waveform. The edge detector is arranged to detect an edge or edges in the delta waveform. Using this methodology, the TRIAC analysis module 57A is able to output a confidence that a TRIAC-type event has occurred. Other data may also be output.

A resistive analysis module 57B (as described in UK Patent Application No. 0819763.4 and International Patent Application No. PCT/GB2009/001754—the contents of both of which are incorporated herein by reference) uses a technique which can identify the characteristic transients developed as a result of the heating of different elements as found in incandescent light bulbs, space heaters and immersion heating systems. The resistive analysis module 57B is arranged to analyse the received electrical values so as to identify a resistive appliance switch-on event. Having identified a resistive event, the resistive analysis module 57B is further arranged to determine: (i) a first value related to the resistance of the appliance at the time of being switched on; and (ii) a second value related to the resistance of said appliance when operating in a steady state. Using this methodology, the resistive analysis module 57B is able to output a confidence that a resistive-type event has occurred and parameters relating to that event (e.g. the first and second values mentioned above). Other data may also be output.

An induction motor analysis module 57C (as described in UK Patent Application No. 0913312.5—the contents of which are incorporated herein by reference) uses a technique which can identify the characteristic transients found as a result of the acceleration of an induction motor. The induction motor analysis module 57C is arranged to identify the operation of an electrical appliance comprising an induction motor when a path traced by real power values against corresponding reactive power values over a time period of interest comprises one or more substantially circular arcs. Using this methodology, the induction motor analysis module 57C is able to output a confidence that a induction motor-type event has occurred. Other data may also be output.

The detector modules 53 of the event detector 52 are designed to detect ‘events’ (e.g. a change in the power consumption of the electricity supply) and are used principally for computational efficiency reasons. Conceptually, it may be possible to run the analysis modules 57 of the analysis engine 56 and the detector modules 53 of the event detector 52 in parallel and combine them at the fuzzy logic module stage with an AND operation (e.g. IF TRIAC-Analysis-Module-Output=high AND Event-Detected=high THEN Conclusion=High-Chance-of-TRIAC-Type-Event). However, it is clear that it is more straightforward to only run the analysis modules 57 of the analysis engine 56 after an event has been detected.

Additionally, some detector modules 53 of the event detector 52 provide an extra ‘analysis module’ functionality. For example, the power of a washing machine ramps up over a number of cycles, in comparison to the power ramp of e.g. a kettle which is effectively instantaneous. Thus a detector module 53 can also provide analysis module functionality. It will be understood that such a functional block exists in both the event detector 52 and also the analysis engine 56 and that it is an implementation issue as to whether there are one or two physical/logical modules.

Around twenty analysis modules 57 are presently used in the NIUM apparatus 20, and thus a system is required to analyse the outputs and draw meaningful conclusions, whilst remaining robust in the high noise environment. A problem facing the NILM (or NIUM) designer is that there are a huge number of appliances in existence and thus, for a single analysis module, it is not straightforward to produce a robust mathematical model for e.g. the level of 3rd harmonic in a fridge motor. This problem is made worse by the large amounts of effectively random noise which is superimposed over the signal. A further problem is that many appliances can be viewed as a combination of other smaller functional blocks. For example, whilst vacuum cleaner consists of a simple induction motor, a tumble dryer has both a heater and a tumble dryer and thus on occasion may display characteristics of both a motor and a heater. The fuzzy logic module 58 has been adopted to provide a language and structure to deal with these fundamentally vague concepts.

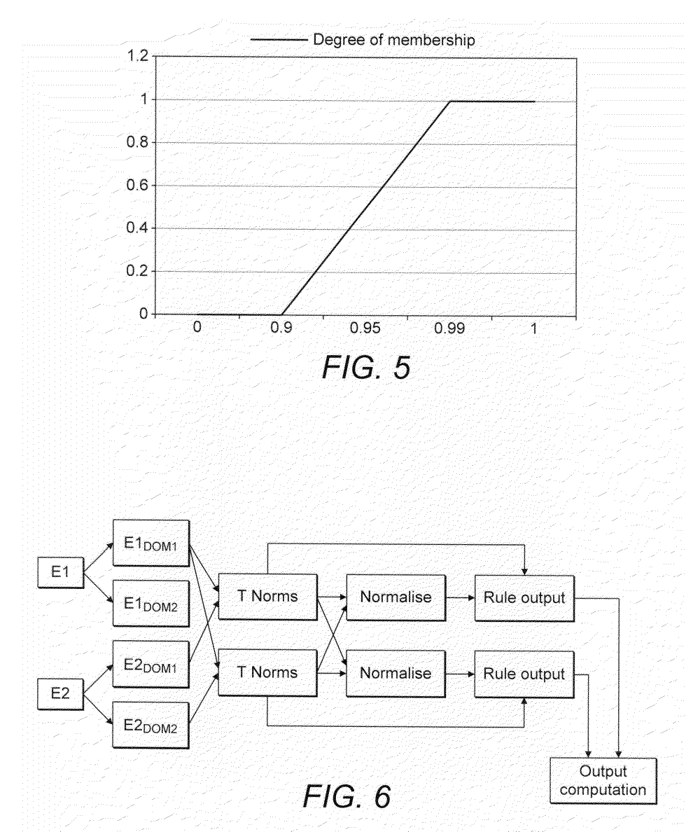

Each analysis module works internally in a different numeric range. For example, the induction motor analysis module 57C indicates the presence of an induction motor if one of the output values is less than 5e-3. In contrast, the resistive analysis module 57B may indicate a strong match if the output is greater than 0.99. However, for a fuzzy system to operate, it is necessary to ‘fuzzify’ these inputs to the fuzzy logic module 58. The fuzzification process is effectively a non-linear transform, and is known as the membership function. The membership function can take any form. As an example, the resistive analysis module 57B may have a membership function as shown in FIG. 5. Thus it can be seen that for resistive inputs of less than 0.99, the Degree Of Membership (DOM) drops off very rapidly.

The goal of a Fuzzy Inference System (FIS) is to attempt to infer conclusions based on uncertain inputs. For example, the goal after having detected an event may be to ascertain whether that event was indicative of a shower turning on, without necessarily having seen that model of shower before. From a human reasoning point of view, one may attempt to detect the shower based on a number of rules:
IF Event-Power=high AND Motor-Power=low AND Resistive-Analysis-Module-Output=high

THEN Conclusion=Shower-Event

On account of noise and uncertainty, we have loose definitions for ‘high’ and ‘low’ in each case. Such a problem can be handled well by a Fuzzy Inference System, such as the fuzzy logic module 58 which is described in more detail below with reference to FIG. 6.

For clarity, FIG. 6 only shows a small number of inputs and outputs. Such a structure is inspired by ‘ANFIS: Adaptive-Network-Based Fuzzy Inference System’ by Jyh-Shing Roger Jang (IEEE Transactions on Systems, Man and Cybernetics, Vol. 23, No. 3, May/June 1993), the contents of which are incorporated herein by reference. Such an architecture is referred to as a Sugeno Fuzzy Inference System and the output is indicative of the conclusion of the system—e.g. a cooker has been turned on.

In FIG. 6, E1 and E2 represent the outputs of two of the analysis modules 57. E1_{DOM1} and E1_{DOM2} represent the membership functions for the first analysis module, and E2_{DOM1} and E2_{DOM2} represent the membership functions for the second analysis module. Multiple DOMs for each analysis module 57 are used to allow the fuzzification over the full range of analysis module outputs. For example, Consider the use of two fuzzy logic rules:
IF Analysis-Module-1-output=large AND Analysis-Module-2-output=large THEN Conclusion-1
IF Analysis-Module-1-output=medium AND Analysis-Module-2-output=large THEN Conclusion-2

In this case, it is clear that Analysis-Module-1 needs to be connected to two membership functions—one to define ‘large’ and one to define ‘medium.’

The T-Norm stage represents a fuzzy ‘AND’ operator. This can be implemented in a number of ways, though the common methods are either multiplication, or a ‘MIN’ operator of the inputs.

The Normalisation layer calculates the ratio of each rule's firing strength to the sum of all the rules' firing strengths and outputs a normalised rule strength. The ‘firing strength’ of a rule may be thought of as an output level for each rule, i.e. the strength of each rule (see also the ‘ANFIS: Adaptive-Network-Based Fuzzy Inference System’ article by Jyh-Shing Roger Jang).

The rule output stage combines the output function of the T-Norm stage with the rule strength. In our simple example (referred to as a ‘Type 1’ system in the ‘ANFIS: Adaptive-Network-Based Fuzzy Inference System’ article by Jyh-Shing Roger Jang), then our output function is a constant such that the rule output stage will output a set of rules and weights/confidences—e.g. Cooker 0.8, Hoover 0.2, where ‘Cooker’ and ‘Hoover’ are the output functions of the T-Norm stage and ‘0.8’ and ‘0.2’ are the associated rule weights.

The final output stage aggregates all of the rules and produces a single output. In a ‘Type 3’ system where each rule output is a numeric value, this stage acts as a summation of all incoming signals. In our example, the output is simply an amalgamation (e.g. an event has the characteristics that make it belong to the cooker set with 0.8 membership, and the hoover class with 0.2 membership).

In conclusion, such a system therefore leads to the designer being able to implement a rule set including rules such as:
IF Analysis-module-1-output=strong

AND Analysis-module-2-output=weak

OR Analysis-module-1-output=weak

AND Analysis-module-3-output=strong

Thus, one can combine the outputs of the analysis modules 57 in a logical fashion whilst accounting for the inherent vagueness which defines the process. Following our noisy measurement of an unknown appliance, we can attempt to classify how ‘cooker like’ (or other-appliance-like) that appliance is compared to how similar it is to other possible appliances by using a set of basic rules.

To summarise, each analysis module 57 effectively provides an output which is indicative of a confidence that the event detected by the event detector 52 and event processing module 54 corresponds to a particular predetermined type of utility usage which is the subject of that analysis module 57. For example, the TRIAC analysis module 57A provides an output indicative of a confidence that a TRIAC-type event has occurred. The output numbers from each of the analysis modules 57 could be combined using the laws of Boolean logic (by constraining the values to 0, 1) or Bayesian logic. However, in the present system, the outputs are advantageously combined using fuzzy logic in the fuzzy logic module 58. One or more of the outputs of the analysis modules 57 are combined using the rules of fuzzy logic in the fuzzy logic module 58 to classify the event. One or more of the outputs of the analysis modules 57 provide information to help match the event.

Each analysis module 57 outputs a respective confidence value indicative of a confidence that the associated predetermined type of utility usage has occurred. Fuzziness is a useful principle since it is not possible to derive meaningful probabilities for many of the events observed and, when combining large numbers of analysis module outputs using the laws of probability, we very quickly derive an answer which is mathematically meaningless, though with the danger that it is perceived to be a precise probabilistic answer.

The outputs of the fuzzy logic module 58 include a number of fuzzy confidences in classification of an event along with various parameters relating to the event itself An example output of the fuzzy logic module 58 is shown in Table 1.

TABLE 1

| Analysis module | Confidence | Parameter 1 | Parameter 2 |
|---|---|---|---|
| Resistive | 0.9 | 500 W | 100 W |
| Induction motor | 0.3 | 1000 W | 0.23 |
| TRIAC | 0.02 | 100 | 0.1 |

Following this exemplary event, we can see that our confidence is high that this is a resistive event and has two parameters (in this case the peak power and the steady state power). Our confidence that it was an induction motor is low, but not insignificant. The two parameters in this case would represent different values. The fuzzy logic module 58 concludes that it is very unlikely that the event was a TRIAC-type event.

The NIUM system can be parameterised in a number of ways. Each analysis module 57 can be parameterised (for example, in our trivial example, our induction motor analysis module 57C runs 50 cycles after an event is detected. However, it may be better to run 40 cycles later). Further, each membership function can be parameterised. Thus, with a suitable training set, it is possible to provide an automated system that performs off-line learning of the most suitable parameters. Such a system is referred to as an ANFIS—Adaptive-Network-based Fuzzy Inference System. Such systems can perform very well since they allow a highly non-linear mapping from the input to output state (a characteristic shared with neural networks). However, in contrast to neural networks, the underlying architecture of the present system (embodied in the fuzzy logic module 58 of the processor 26) is simple to understand thus it can be easily designed and maintained. This is in contrast to many neural network implementations which very much operate as a ‘black box’ type system where good results can be obtained at the expense of highly limited visibility of the actual reasoning process.

Following the successful detection and classification of the event, the event identification module 60 is used to identify the specific appliance which is the source of the event. At this point, the characterising parameters of the event are compared to those of known ‘appliances’ held in the database 29 of the memory 28 and look for suitable matches. For example, considering our event above from Table 1, we would look to fuzzily match for resistive type appliances which match the identified parameters. If there is no good match, we would add a new appliance. However, if there was a high chance that the event was also an induction motor then we would look to match for an induction motor as well, though as a rule, the goal of the fuzzy logic module 58 is to produce only one clear candidate for matching.

The correction engine 62 acts in parallel to the main system and continually analyses the database 29 to look for inconsistencies in the matching. An initial problem in matching is how to set the matching tolerances since there is no prior measure of the variability of the parameters to be matched. For example, a light bulb will have a measured power consumption which varies by only 1% plus background noise. However, the power consumption of a vacuum cleaner may vary by as much as 5%, hence it is a non-trivial problem to decide whether on the edge of tolerance, one should create a new appliance, or match to an existing appliance. The correction engine is designed to cope with such problems and to correct any incorrect appliance identifications.

### (3) Display

The above processing has previously been described in UK Patent Application No. 1000695.5, the contents of which are incorporated herein by reference. In summary, the processor 26 takes in utility consumption measurements (e.g. voltage and current measurements, water flow rate, etc.) for an entire household (or other collection of a plurality of appliances/devices) and processes this data to determine which appliances are responsible for the utility consumption. Thus, the processor 26 disaggregates (or separates out) the utility consumption into individual utility consumptions for specific appliances. It will be appreciated that other NIUM apparatus (with different configurations and/or processing from that described above) could be used to perform similar processing of utility consumption data to identify individual utility consumptions by specific appliances and their respective levels of utility usage. Whatever the processing used to arrive at this disaggregation information, it is advantageous to output the results of the processing to the user so that the user may adjust his appliance usage to reduce his utility consumption if desired, thereby achieving energy/utility and cost savings.

As mentioned above, information on the usage of a utility may be output to a user (e.g. displayed or annunciated) by the NIUM apparatus 20 itself (e.g. via the output section 40). Additionally or alternatively, the NIUM apparatus 20 may use the output section 40 to transmit this information to a user terminal 42 which may then output the information to a user (e.g. via the display 44 and/or via the printer 46 and/or via a speaker). The location of the actual output to the user is not important for embodiments of the invention—embodiments of the invention concern how the information is output efficiently, usefully and meaningfully, regardless of from where the information is to be output.

When a terminal 42 remote from the NIUM apparatus 20 is being used, the processing performed to generate the final output to the user may be performed y a processor at the terminal 42 (with the NIUM apparatus 20 using its output section 40 as an interface to supply raw disaggregation data to the terminal 42 for the terminal 42 to then compile into a user interface/output for presentation to a user). Alternatively, the processing performed to generate the final output to the user may be performed by the processor 26 at the NIUM apparatus 20, with the terminal 42 simply outputting a signal (e.g. video signal or audio signal) received from the output section 40 of the NIUM apparatus 20. It will also be appreciated that the processing performed to generate the final output could be shared between the NIUM apparatus 20 and the terminal 42.

Thus the NIUM apparatus and/or the terminal 42 may comprise any suitable user-interface components for providing information to a user and/or receiving information from a user. These components may comprise a screen/monitor/display, such as the display 44 or one that is integral with the output 40, for providing a graphical user interface to the user. These components may comprise a speaker for providing an audio output to a user. These components may comprise any input means for receiving input from a user, such as a mouse (or other pointing device) and/or a keyboard. The input means may be integral with a display (such as using a touch-screen monitor). As described below, a user may make selections of various icons/options that may be displayed on a display window or user interface—such selections may be performed by any suitable method, e.g. by pressing an option/icon displayed on a touch-screen monitor, using a mouse to move a cursor to an option/icon and then clicking on that option/icon, or using a keyboard to enter values and/or to tab between options/icons.

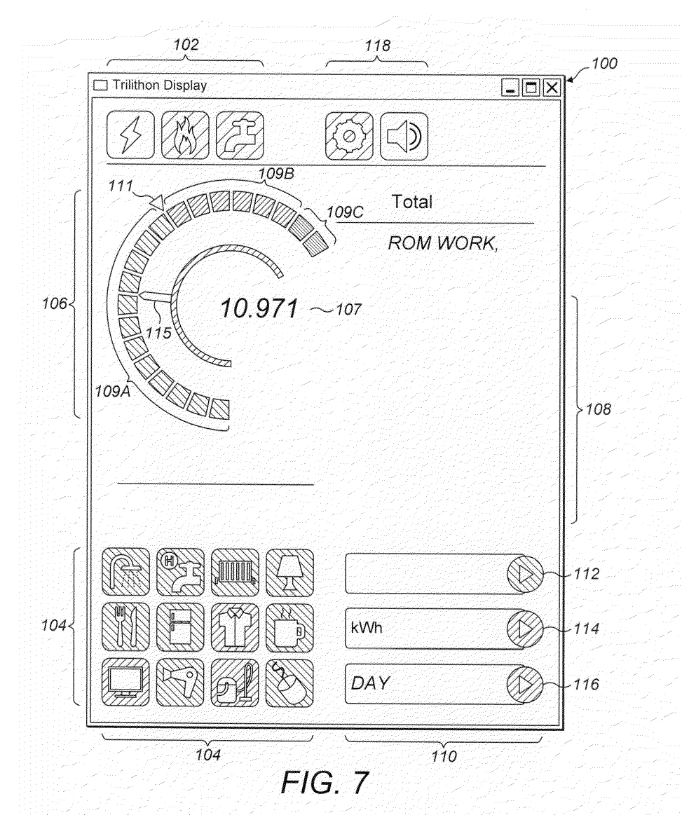

FIG. 7 shows one embodiment of a display window (or graphical user interface) 100 for outputting utility disaggregation information visually to a user and for receiving inputs from a user, as will be described in more detail below. The window 100 is displayed to the user by any suitable method, as has been described above. The display window 100 may be generated, and maintained, by the processor 26 of the NIUM apparatus 20 and/or the terminal 42. Interaction with the display window 100 may handled by the processor 26 of the NIUM apparatus 20 and/or the terminal 42

The display window 100 comprises utility icons 102, appliance category icons 104, a first display region 106, a second display region 108, display setting buttons 110, and other icons 118.

Three utility icons 102 are shown in FIG. 7. From left to right, the icons are representative of electricity, gas, and water, but it will be appreciated that additional or alternative utilities (such as oil) could be represented by additional or alternative icons accordingly. Whilst only three utility icons 102 are shown in FIG. 7, in other embodiments a different number of utility icons 102 may be displayed—indeed, in some embodiments no utility icons 102 are displayed so that the user interface 100 is specific to a particular utility. By selecting a utility icon 102 (e.g. the user pressing a utility icon 102 on a touch screen), the user may select a corresponding utility about which the user wishes to be provided with information. In FIG. 7, the electricity icon has a white background, indicating that electricity has been selected by the user as the utility of interest. Thus, the display window 100 is set up to display electricity usage information in the configuration of FIG. 7. The utilities which are not currently selected (gas and water) have icons with a different colour background (e.g. light blue). It will be appreciated that methods other than colour changes may be used to indicate which utility icon 102 (and hence which associated utility) has currently been selected, such as changing the border or size of a utility icon 102.

The description below shall focus on electricity as the utility which the user has selected. However, it will be appreciated that the following description applies equally to other utilities that the user may select (albeit with different units of measurement for consumption levels of the utility).

The first display region 106 is used to display information on the current total level of usage of the selected utility by all of the appliances 12 combined. The first display region may have a numerical display 107 and/or a graphical dial display 109.

The graphical dial display 109 may be a colour-coded display, with the colours representing different levels of utility usage. For example, the graphical dial display 109 may comprise a plurality of differently coloured regions. In the embodiment of FIG. 7, there are green (109A), yellow (109B) and red (109C) portions indicative of “normal” usage, “abnormal” usage, and “high” utility usage respectively, although it will be appreciated that other numbers of regions could be used and with different colours. These portions are scaled based on a usual/typical/baseline consumption of the utility. There may be a plurality of possible baselines, dependent on a number of factors, such as factors relating to a household (e.g. one or more of house size, number of adults, number of children, geographical location, time of year, etc.). These baselines may be static, but could be configured to update based on peer comparison with an internet connection. In one embodiment, a user may select a particular baseline to use.

The graphical dial display 109 may include an indication of the accumulated utility consumption (integral of consumption level over time) over a specified integration period. Thus, the NIUM apparatus 20 and/or the terminal 42 may be arranged to calculate such accumulated utility consumption values. In the embodiment of FIG. 7, this indication is a small white triangle 111 disposed outside the dial—however, it will be appreciated that other methods of indicating this quantity on the graphical dial display could be used. The integration period for the accumulated energy consumption display (small triangle external to the dial) may be altered if desired. One of the display settings buttons 110 is an integration period button 116. Possible integration periods are a day, a week, or a month, although other integration periods could be used instead. The user may therefore select the integration period button 116 (or otherwise interact with the user interface 100) to change the integration period (e.g. selecting from a predetermined list of possible integration periods or inputting a specific integration period). The different colour regions then represent different levels (e.g. high, low, normal, etc) of usage of the utility relevant to the selected integration period. In FIG. 7, the integration period is set to be one day.

In FIG. 7, the selected utility is electricity and the numerical display of the first display region 106 indicates that the total/combined energy consumption by all of the appliances 12 over the integration period is currently 10.971 kWh. In other words, the level of energy consumption accumulated over a period of time is currently 10.971 kWh. Thus, the numerical display may be used to display the same information as the small white triangle 111 (albeit with the actual numerical value displayed). However, the use of the colour coding on the graphical dial display (and elsewhere as discussed in more detail below) allows a user to quickly gauge whether the current level of utility consumption/usage is low, normal, high, etc. without the user necessarily having to understand units of measurement or whether a specific number is actually low, normal or high etc. In particular, most consumers would not know whether 10.971 kWh is high or low—however, the use of the colour coding makes it clear that this level of electricity usage is normal.

The numerical values of utility consumption may be shown in different units if desired. One of the display settings buttons 110 is a units button 114. Possible units relevant to electricity consumption are kWh, g of CO₂ or monetary cost. The monetary cost can be estimated—however, it could also be dynamically updated e.g. via an internet connection to a utility supplier's website. The user may therefore select the units button 114 (or otherwise interact with the user interface 100) to change the units of measurement for the usage level of a utility.

The current instantaneous level of utility consumption may also be shown on the graphical dial display by means of a pointer 115 (which, in the embodiment of FIG. 7, is disposed inside the dial). This may be actual current level of utility consumption based on the latest utility consumption values (so that, for electricity consumption, the pointer 115 could indicate the current level of consumption as a level of power in kW for example); alternatively, this may be a cumulative level of utility consumption over a short integration period, e.g. 1 second (so that, for electricity consumption, the pointer 115 could indicate the current level of consumption as an energy level in kWs for example). Thus, in the embodiment shown in FIG. 7, the graphic dial display indicates the level of consumption of the utility over a time period in addition to representing an instantaneous utility usage, albeit on different scales. However, the usage of the different coloured regions makes displaying both instantaneous and accumulated utility consumption easier and more accessible. The coloured regions on the graphical dial display represent different units of measurement and different numerical ranges for the cumulative utility consumption over the integration period and for the instantaneous utility consumption. It will be appreciated that if the user set the integration period to be “now” (representing an instantaneous integration period), then the pointer 115, the triangle 111 and the numerical display 107 will represent the same quantity.

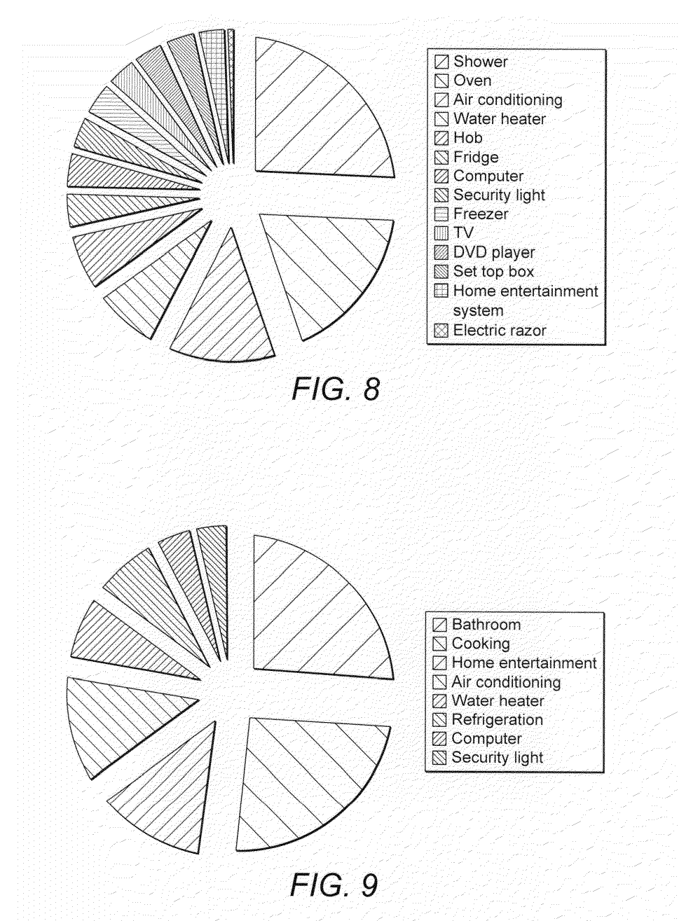

When displaying disaggregated energy consumption, it is not straightforward to display the information in a way which is relevant to, or understandable and accessible by, the consumer. Consider, for example, the ‘sample’ itemised electricity bill shown in Table 2 and further consider that a real house may have many additional/alternative items on this bill. The information shown in Table 2 is also shown graphically in the exploded pie chart of FIG. 8.

TABLE 2

| Item/appliance/device | Cost |
|---|---|
| Shower | $2.00 |
| Oven | $1.50 |
| Air conditioning | $1.00 |
| Water heater | $0.60 |
| Hob | $0.50 |
| Fridge | $0.30 |
| Computer | $0.30 |
| Security light | $0.29 |
| Freezer | $0.28 |
| TV | $0.27 |
| DVD player | $0.26 |
| Set top box | $0.25 |
| Home entertainment system | $0.24 |
| Electric Razor | $0.05 |

Note that whilst table 2 is shown using monetary cost as a measure of the level of utility usage, other units could be used instead and the following discussion applies analogous to those other units.

For a consumer to realise monetary and/or energy/utility savings, it is important to draw his attention to the most expensive devices (i.e. those devices consuming the greatest amount of a utility or those devices incurring the highest costs). However, in this particular case, whilst it is obvious that making savings to the oven and shower usage may help, it is not immediately obvious that the TV and associated appliances (e.g. DVD player, set top box, home entertainment system) are the third most expensive items in the house to run as a group since they always/normally operate together.

By grouping (or categorising or classifying) appliances together in logical categories/groups/classes the user can more quickly analyse the data and realise real savings. Examples of such categorisations are shown in Table 3 and the corresponding exploded pie chart of FIG. 9 (although it will be appreciated that different categories, and different numbers of categories, may be used). In this example below, it becomes immediately obvious where the top 75% of energy is being used.

TABLE 3

| Appliance category | Appliances in appliance category | Cost |
|---|---|---|
| Bathroom | Shower, Razor | $2.05 |
| Cooking | Oven, Hob | $2.00 |
| Home entertainment | TV, DVD player, Set top box, Home | $1.02 |
| | entertainment system | |
| Air conditioning | Air conditioning | $1.00 |
| Water heater | Water heater | $0.60 |
| Refrigeration | Fridge, Freezer | $0.58 |
| Computer | Computer | $0.30 |
| Security light | Security light | $0.29 |

In order to allow a user to view disaggregated utility consumption/usage level information in the display window 100, twelve appliance category icons 104 are provided at the bottom left of the display window 100 in FIG. 7. An “appliance category” comprises a group of related appliances. The twelve appliance category icons 104 shown in FIG. 7 are representative of (from left to right, top to bottom) “shower”, “water heating”, “space heating”, “lighting”, “cooking”, “refrigeration”, “laundry”, “hot drinks”, “home entertainment”, “personal care”, “cleaning” and “computer equipment” appliance categories. Clearly, this list is not exhaustive, and may be altered, or added to as necessary. For example, additional icons could be added to represent “standby” and “garden equipment” appliance categories. “Standby” would include background energy usage such as the television being in standby mode. A different number of appliance categories icons 104 (representing associated appliance categories) may be displayed and the display of the appliance category icons 104 may occur in different arrangements and/or at different positions on the display window 100 from that shown in FIG. 7.

The appliances belonging to an appliance category may be considered to be related based on one or more criteria, such as: physical location (e.g. kitchen appliances, living room appliances, bathroom appliances, garden appliances, etc.); purpose; semantic nature (e.g. media devices or entertainment devices); natural association (e.g. washing machine and tumble dryer); temporal association (e.g. devices that are normally used at the same time, or during a given time interval, or at approximately the same time of day, etc.); etc. The appliance types belonging to an appliance category may be predetermined, with this being stored as configuration data at the NIUM apparatus 20 or the terminal 42. However, as discussed below, the make-up of the various categories may be dynamically determined based on the actual utility usage by appliances.

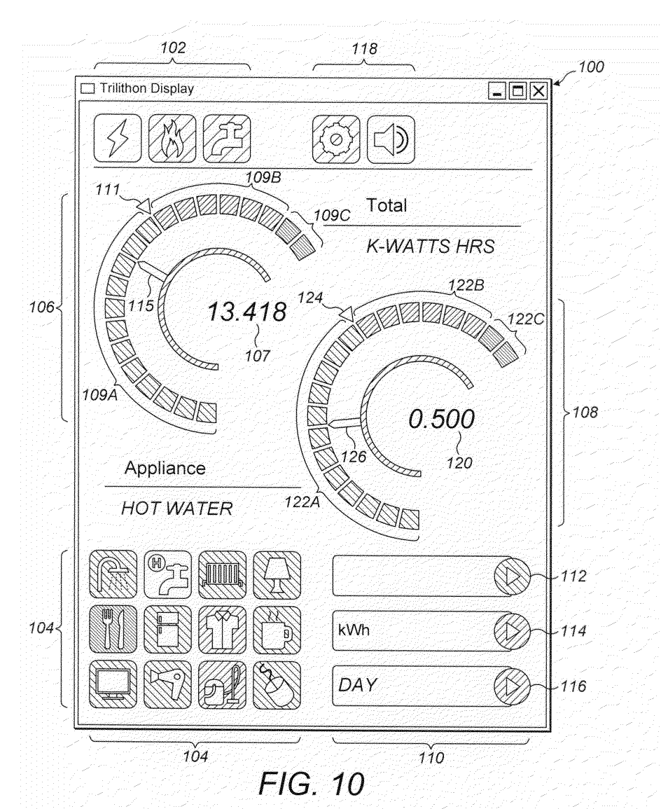

A user may select an appliance category by selecting the corresponding appliance category icon 104 (e.g. by pressing that icon 104 via a touch screen). If one of the appliance category icons 104 is selected, then utility consumption information related to that appliance category is displayed in the second display region 108. An appliance category icon 104 which has been selected by the user may be shown using a predetermined colour (e.g. by having a white background). None of the appliance category icons 104 have been selected in FIG. 7, so no energy consumption information is shown in the second display region 108. In contrast, the “water heating” appliance category icon 104 has been selected in FIG. 10, so a current total level of usage of electricity relating to water heating is shown in the second display region 108 of the display window 100 of FIG. 10. The “water heating” energy consumption is shown both numerically 120 (i.e. 0.500 kWh) and on a graphical dial display 122 in the second display region 108 (in a similar manner to the numerical display and graphical dial display provided in the first display region 106). It is thus easy to compare the information displayed in the first and second display regions 106 and 108 to assess what proportion of the total utility consumption is currently attributable to the selected appliance category. Thus, the display of information relating to the level of utility usage by appliances belonging to an appliance category (both instantaneous usage 126 and/or integrated usage 120, 124) can be provided in the second display region 108 in the same way as this information was provided in the first display region 106 in relation to all of the appliances combined. Of course, the user interface 100 could also display a percentage value (or some other indication) to represent the proportion of the total overall utility usage that is attributable to just the appliances in the currently selected appliance category.

The icon/representation used for an appliance category icon 104 may be changed to indicate different conditions. This may involve changing the actual pictorial representation, changing a colour, border or size of the representation, creating a flashing effect, etc. In one embodiment, the background colour of each appliance category icon 104 is changed to indicate different conditions. A white background corresponds to the currently selected appliance category. A green background corresponds to low energy consumption by that appliance category. A yellow background corresponds to medium energy consumption by that appliance category. A red background corresponds to high energy consumption by that appliance category. A blue background corresponds to no energy consumption by that appliance category. By using these different representations, the user may be provided with an easily interpretable and accessible indication of the current total level of utility usage for each of the appliance categories.

Thus, in FIG. 7, there is low energy consumption by the “shower”, “water heating”, “space heating”, “lighting”, “cooking”, “refrigeration”, “hot drinks”, “personal care” and “computer equipment” appliance categories, and there is no energy consumption by the “laundry”, “home entertainment” and “cleaning” appliance categories.

In contrast, in FIG. 10, there is high energy consumption by the “cooking” appliance category, there is low energy consumption by the “shower”, “space heating”, “lighting”, “refrigeration”, “hot drinks”, “home entertainment”, “personal care” and “computer equipment” appliance categories, and there is no energy consumption by the “laundry” and “cleaning” appliance categories. The “water heating” appliance category is selected in FIG. 10, and it can be seen from the second display region 108 that the current energy consumption by the “water heating” appliance category is low (i.e. the pointer is in the green region of the graphical dial display), but that the accumulated energy consumption over the past day by the “water heating” appliance category has been borderline low/medium (i.e. the small white triangle is on the border of the green/yellow regions of the dial).

The appliance grouping system helps to present the utility disaggregation information clearly and simply to a user. However, in some situations using predetermined appliance categories may obscure information as well. For example, in the Table 3 categorisation above, the shower and razor have been grouped together into the “bathroom” category, which makes logical/semantic sense. However, from the uncategorised data in Table 2, it is clear that the shower consumes the vast majority of the energy used by the “bathroom” appliance category. Hence, if a user is to make energy/cost savings, it would be desirable to make it clear to a user that he should take shorter showers, instead of growing a beard (i.e. he should focus on reducing the shower energy consumption, rather than reducing the razor energy consumption).

In one embodiment, this problem may be solved by allowing the user to click on the “bathroom” appliance category icon 104, at which point the user is provided with details of the energy consumption by the various appliances in that category so that the user may gain a more detailed understanding of their energy consumption. However, such embodiments increase the complexity of the display window 100, which might then become confusing to a user. Therefore, in one embodiment, an algorithm can be employed to promote appliances into their own category if it is warranted. In this case, it is clear that the shower should be promoted out of the bathroom category and into its own unique category for display purposes.

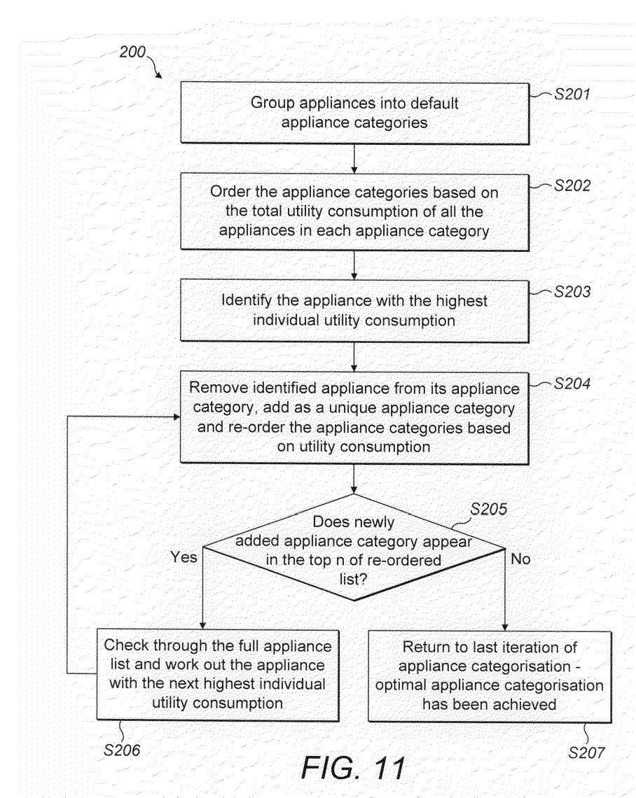

FIG. 11 is a flowchart schematically illustrating a method 200 for dynamically creating, and modifying the membership of, appliance categories. It will be appreciated, however, that this is merely one example of how such dynamic grouping may be achieved and that other methods may be employed by the NIUM apparatus 20 and/or the terminal 42 to change the categorisation of appliances so as to provide more useful groupings (i.e. groupings which enable more pertinent information to be provided to a user).

At a step S201, the individually identified appliances are grouped into logically semantic categories, such as “cooking”, “cleaning, “bathroom”, etc., as described above. Such categories may be predetermined, i.e. a set of default categories may be used.

At a step S202, for each appliance category, the total/combined level of utility consumption by all of the appliances in that category is determined. This may be based on the instantaneous utility consumption values or utility consumption values integrated over an integration period. The appliance categories are then ordered based on their respective total/combined levels of utility consumption. An example of this ordering is shown in Table 3.

At a step S203, the respective utility consumption levels of individual appliances are considered, regardless of appliance category. Again, this may be based on the instantaneous utility consumption values or utility consumption values integrated over an integration period. Out of the appliances that are not in an appliance category of their own, the appliance with the highest individual utility consumption is identified. Thus, referring to the example shown in Table 2, the shower is the appliance with this highest individual utility consumption level.

At a step S204, the appliance with the highest individual degree/amount of utility consumption is removed from its appliance category (e.g. the shower is removed from the “bathroom” appliance category). A new appliance category is created having the removed appliance as its only member. The appliance categories are then re-ordered as described above for the step S202.

At a step S205, the re-ordered appliance category list is analysed to assess whether or not the newly added appliance category is in the top n appliance categories in terms of level of utility consumption. The value of n represents the number of different appliance categories selectable via the user interface 100—in the example shown in FIGS. 7 and 10, the value of n is 12 (as there are 12 appliance category icons 104). However, n may be any number appropriate for a particular application and display device, where n is chosen so as to be able to convey enough information without overloading the consumer with information.

If the newly added appliance category has a sufficiently high level of utility usage such that it is in the top n appliance categories, then processing continues at a step S206 at which the full appliance list is reviewed again to find, out of the appliances that are not in an appliance category on their own, the appliance with the next (or now) highest individual level of utility consumption. Processing then returns to the step S204 to remove this appliance from its current appliance category and to create a brand new appliance category for that appliance alone. Then, the algorithm returns to the step S205 to again assess whether or not the newly added appliance category is in the top n appliance categories in terms of utility consumption. If the answer is yes, this iterative process continues until sufficient new appliance categories have been created so as to provide the user with the appropriate level of energy usage information.

Eventually, the most newly created appliance category will not appear in the top n appliance categories in terms of utility consumption. At this stage, the processing moves from the step S205 to a step S207 at which the most newly created appliance category is cancelled and the associated appliance is returned to its previous appliance category. Additionally, any small consumption categories near the bottom of the list may be combined into an “other” appliance category if desired (e.g. the n^{th} and lower categories may be combined to form an “other” category). The display window 100 may then be updated to reflect the new appliance categories.

The processing of FIG. 11 may be performed as a continuous background process, it may be performed at predetermined time intervals, or it may be performed upon receipt of a request from a user.

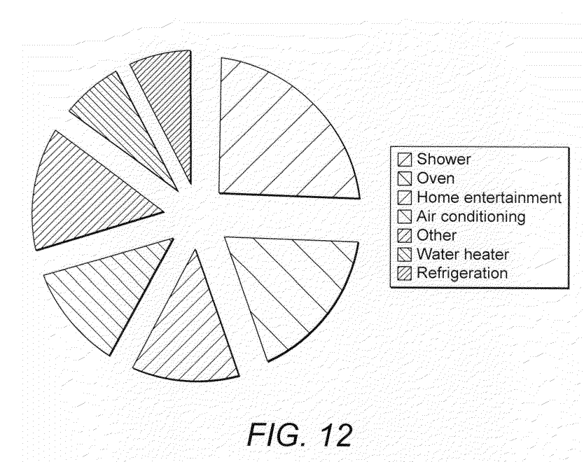

Table 4 shows an example of the output of the method 200 shown in FIG. 11 using n=7 when starting from the categorisation shown in Table 3 and using the utility consumption levels shown in Table 2. In particular, the shower appliance is first removed from the “bathroom” appliance category at the steps S203 and S204, such that the razor is automatically left in a “bathroom”/“razor” appliance category of its own. The oven is then removed from the “cooking” category as the second (or now) highest utility consumption appliance not in its own category; the hob is consequently automatically left in a “cooking”/“hob” appliance category of its own. The next largest individual appliance consumption (out of the appliances that are not in a category of their own) is the fridge. However, if the fridge is put into its own category, it would not fall in the top 7 in terms of utility consumption (the top 7 at this stage would be “Shower”, “Oven”, “Home entertainment”, “Air conditioning”, “Water heater”, “Hob” and “Computer”). Therefore, the fridge is not put into an appliance category of its own. All appliance categories that are not in the top 6 (i.e. from the nth downwards) are combined to form an “other” appliance category. The data from Table 4 is also shown in an exploded pie chart in FIG. 12.

TABLE 4

| Appliance category | Appliances in appliance category | Cost |
|---|---|---|
| Shower | Shower | $2.00 |
| Oven | Oven | $1.50 |
| Home entertainment | TV, DVD player, Set top box, Home | $1.02 |
| | entertainment system | |
| Air conditioning | Air conditioning | $1.00 |
| Water heater | Water heater | $0.60 |
| Refrigeration | Fridge, freezer | $0.58 |
| Other | Razor, Hob, Computer, Security light | $1.14 |

In a modified dynamic categorisation algorithm, n may be automatically determined by making sure that the “other” category is smaller than the next largest category by iteration.

It may also be possible for a user to themselves specify which appliance category one or more of the appliances belong. For example, depending on their computer usage, a user may decide that they would like their computer to always form part of the “Home entertainment” appliance category. As another example, a user may specify that two or more specific appliances should always belong to the same appliance category. Such user-specified appliance categorisations may form a constraint on the dynamic appliance categorisation described above.

Alternatively, in embodiments that do not make use of such dynamic appliance categorisation, the user interface 100 may allow a user to set up or configure the appliance categories manually (i.e. the user may provide input to the user interface 100 specifying precisely which appliances belong to which appliance categories).

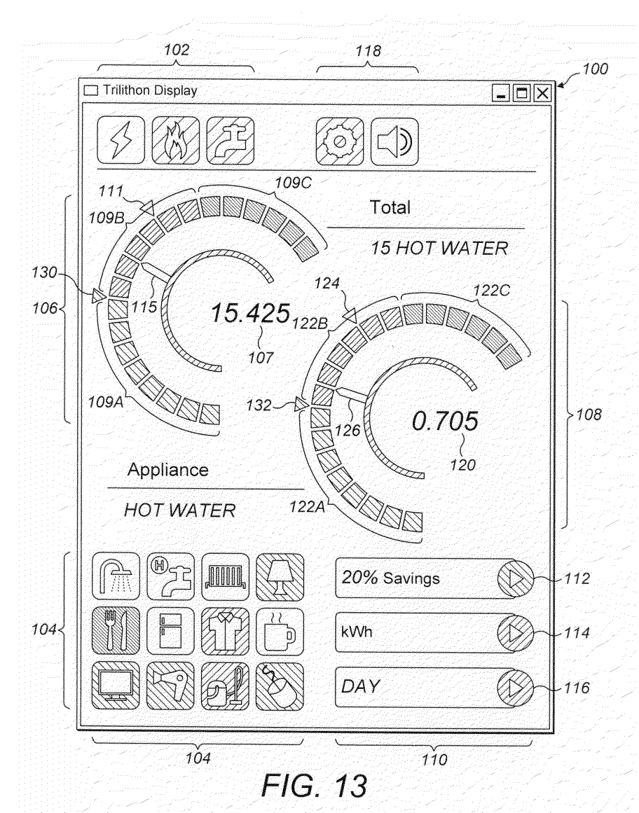

FIG. 13 shows another screen shot of the display window 100, this time with “savings mode” activated. Savings mode is activated using a savings button 112, which is one of the display setting buttons 110. In FIG. 13, the user has set a utility usage saving target of 20%—it will be appreciated that other saving targets may be provided by the user (e.g. selected from a predetermined list of targets or by the user entering a specific target value). The display window 100 now shows an indication 130, 132 of a target utility consumption level required in order to achieve the required 20% saving. In FIG. 13, these indications are a small green triangle 130 disposed outside the graphical dial display in the first display region 106 (to indicate a target utility consumption level across all appliances) and another small green triangle 132 disposed outside the graphical dial display in the second display region 108 (to indicate a target utility consumption level across the appliances belonging to the currently selected appliance category). It will be appreciated that other indications may be used.

In addition, when savings mode is activated, the colour scales (e.g. the green, yellow and red colour portions) on each of the graphical dial displays may be rescaled according to the target saving (in this example, scaled down by 20%). Similarly, the use of the savings mode may also change how appliance category icons 104 are represented (e.g. the threshold usage levels that determine when a colour or other aspect of an appliance category icon 104 is changed). In particular, in FIG. 13, there is now high energy consumption by the “cooking” appliance category, there is medium energy consumption by the “shower”, “space heating”, “refrigeration”, and “hot drinks” appliance categories, there is low energy consumption by the “lighting”, “home entertainment”, “personal care” and “computer equipment” appliance categories, and there is no energy consumption by the “laundry” and “cleaning” appliance categories. The “water heating” appliance group is selected in FIG. 13, and it can be seen from the second display region 108 that the energy consumption by the “water heating” appliance category is medium.

In alternative embodiments, the display window 100 could be arranged differently. For example, the various display areas (i.e. the utility icons 102, the appliance category icons 104, the first and second display regions 106 and 108, the display setting buttons 110, and the other icons 118) could be positioned differently with respect to one another. There may be other display areas in addition to those shown in FIGS. 7, 10 and 13. Also, some of the display areas shown in FIGS. 7, 10 and 13 may not be on display in some configurations.

In addition, both the colouring of the appliance category icons 104 (be that foreground or background colouring) and the coloured graphical dial displays could have a different number of discrete colour categories. Alternatively, both the colouring of the appliance category icons 104 (be that foreground or background colouring) and the coloured graphical dial displays could use a continuous spectrum of colours rather than using the discrete colour categories shown in FIGS. 7, 10 and 13.

The shapes and sizes of the various icons, dials, fonts etc. may be changed for other embodiments of the invention.

It will be appreciated that, in addition to, or in place of, the colour coding mentioned above, the user interface 100 may display wording (or some other indication) to indicate how high or low the utility usage is (e.g. “high”, “low”, “normal”, “extremely high”, “none”, etc.). As another example, the colour coding may be supplemented by, or replaced by, a numbered scale (e.g. from 0 to 10, with 0 representing no utility usage, 1 representing low utility usage and 10 representing high utility usage). These alternatives to the colour coding may be based on the same/similar baselines as discussed above for the colour coding.

The relevance of the display to the consumer may also be improved by calculating and displaying the “cost per usage” of one or more of the appliances 12. For example, instead of displaying a cost of e.g. $10 for the “hot drinks” appliance category over a month, it would instead be possible to display $0.50 per kettle boil or, in this case, $0.10 per cup of water boiled.

The NIUM apparatus 20 and/or the terminal 42 may have a network connection for enabling the NIUM apparatus 20 and/or the terminal 42 to communicate over a network. This communication could be a wireless connection or may be via a network cable. The network could be the internet, a wide area network, a local area network, a metropolitan area network, a telecommunications network, or any other network via which the NIUM apparatus 20 and/or the terminal 42 is capable of transmitting and receiving data. The NIUM apparatus 20 and/or the terminal 42 may then use a network connection to request and/or receive (e.g. periodically as a subscriber to a service) information from various data sources to provide an even further enhanced user interface. For example:
The NIUM apparatus 20 and/or the terminal 42 could obtain information about current (or real time) carbon and/or utility pricing from a relevant source on the network. In this way, the user interface 100 could be arranged to display utility usage in terms of up-to-date pricing and/or carbon cost. The user could select such pricing and/or carbon cost as the unit of measurement via the units button 114.
The NIUM apparatus 20 and/or the terminal 42 could provide to a central server information about the utility usage that it is measuring. The central server could then aggregate all of the information it receives from numerous NIUM apparatus 20 and/or terminals 42 so that a comparison of a particular utility usage by a particular NIUM apparatus 20 and/or terminal 42 against a population of other NIUM apparatus 20 and/or terminals 42 can be made. For example, a NIUM apparatus 20 and/or terminal 42 could receive (and then display on the user interface 100) information from the server indicating whether the utility usage corresponding to that NIUM apparatus 20 and/or the terminals 42 is relatively high or low in comparison to a relevant group of other NIUM apparatus 20 and/or terminals 42 (e.g. those in the same neighbourhood or some other specific geographic area; those with similar sized families or households; those with a similar demographic or age; etc.). The comparison could be based on real time (instantaneous) utility usage data or historical utility usage data. Moreover, as discussed above, the baselines used for setting colour coding (or other levels of utility indication) could be calculated by such a central server and provided to the various NIUM apparatus 20 and/or terminals 42—these baselines could be determined based demographics, geographic area, etc.
The NIUM apparatus 20 and/or the terminal 42 could access up-to-date (i.e.

current or real time) pricing information related to the supply/provision of a utility. The pricing information could relate to the prices charged by different utility suppliers for the supply of that utility and/or to different prices/tariffs charged by a single utility supplier that offers different utility supply packages with different charge rates and conditions etc. Based on this pricing information, the NIUM apparatus 20 and/or the terminal 42 could arrange for a change from a current utility supplier and/or a current utility supply package to a different utility supplier and/or a current utility supply package that offers cheaper (or the cheapest) prices/rates, e.g. by sending relevant messages to existing and/or new utility suppliers over the network (or otherwise interfacing with an interface, such as a webpage, of existing and/or new utility suppliers) to request the desired change.

In one embodiment, the NIUM apparatus 20 and/or the terminal 42 is arranged to receive and/or take into account information indicating temperature (e.g. the temperature outside the household that is using the NIUM apparatus 20). This may involve the NIUM apparatus 20 and/or the terminal 42 having its own thermometer (or other temperature gauge) and/or the NIUM apparatus 20 and/or the terminal 42 receiving temperature information from some other source (e.g. from a source over a network if the NIUM apparatus 20 and/or the terminal 42 has a network connection as discussed above). This could, however, simply be based on the current time of year (as calculated by the NIUM apparatus 20 and/or the terminal 42 using a clock), so that the NIUM apparatus 20 and/or the terminal 42 can infer that the temperature might be below a yearly average in winter and above a yearly average in summer etc. The NIUM apparatus 20 and/or the terminal 42 could then be arranged to adjust the user interface 100 based on this temperature information (e.g. by changing various settings). For example, if the weather is cold or hot (or colder or hotter than expected for a certain time of year), then the user interface 100 could be adapted to adjust the various coloured coding for utility usage (e.g. the specific regions indicating low, medium, normal, high, etc. utility usage) accordingly (e.g. increasing/decreasing their upper bounds by an extra 5% or some other quantity in accordance with the temperature being colder/hotter than normal). This may be applied to only specific appliance categories (e.g. cooking and heating bands may be higher for winter months).

In one embodiment, the NIUM apparatus 20 and/or the terminal 42 may be arranged to detect changes in the characteristics of an appliance and to identify from these changes that a failure of the appliance may be imminent. For example, as a central heating pump ages, its bearings and motor system become less efficient and start to draw more power, before finally failing. Upon detecting such a possible failure of an appliance, the NIUM apparatus 20 and/or the terminal 42 could arrange for the user interface 100 to display a warning or raise some other alarm. This could take the form of a flashing appliance group icon 104 indicating that there is a fault in the group. The user could then press this appliance group icon 104 and a textual display could inform the user of the suspected fault. Of course, other methods of providing a warning could be provided.

Thus, it should be clear that the preferred embodiments described above are by way of example only, and that various modifications to the invention may be contemplated.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program,” as used herein, may be a sequence of instructions designed for execution on a computer system, and may include a subroutine, a function, a procedure, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method of outputting to a user an indication of the usage of a utility, the method comprising:
obtaining data indicating, for each of a plurality of appliances, a respective current level of usage of the utility by that appliance;
for each of a plurality of appliance categories, using the obtained data to calculate a respective current total level of usage of the utility by appliances belonging to that appliance category; and
outputting an indication of the calculated current total level of usage of the utility for at least one of the plurality of appliance categories.

2. A method according to claim 1, comprising allowing a user to select an appliance category from the plurality of appliance categories, wherein said outputting comprises outputting an indication of the calculated current total level of usage of the utility for the selected appliance category.

3. A method according to claim 1, comprising:
using the obtained data to calculate a current total level of usage of the utility by the plurality of appliances; and
outputting an indication of the calculated current total level of usage of the utility by the plurality of appliances.

4. A method according to claim 1, in which said outputting comprises displaying on a display an indication of the calculated current total level of usage of the utility for the at least one of the plurality of appliance categories.

5. A method according to claim 4, comprising:
for each appliance category, displaying an associated icon to represent the appliance category;
wherein said outputting comprises setting a colour of an icon to indicate the calculated current total level of usage of the utility for the appliance category associated with that icon.

6. A method according to claim 5, wherein said setting a colour of an icon comprises selecting a colour for the icon from a predetermined set of colours, wherein each colour in the predetermined set of colours represents an associated range of levels of usage of the utility.

7. A method according to claim 6 comprising, for at least one of the colours in the predetermined set of colours, adjusting the associated range of levels of usage of the utility based on an input from the user.

8. A method according to claim 4, in which said outputting comprises indicating, on a scale with colour-coding, the calculated current total level of usage of the utility for the at least one of the plurality of appliance categories.

9. A method according to claim 8 comprising adjusting the colour-coding of the scale based on an input from the user.

10. A method according to claim 4, in which said outputting comprises displaying a numerical value indicating the calculated current total level of usage of the utility for the at least one of the plurality of appliance categories.

11. A method according to claim 1, comprising:
using the obtained data to calculate a level of usage of the utility by the plurality of appliances over a period of time;
outputting an indication of the calculated level of usage of the utility by the plurality of appliances over the period of time.

12. A method according to claim 1, comprising, for at least one of the plurality of appliance categories:
using the obtained data to calculate a level of usage of the utility by appliances belonging to that appliance category over a period of time;
outputting an indication of the calculated level of usage of the utility by appliances belonging to that appliance category over the period of time.

13. A method according to claim 1, comprising allowing a user to specify which of the plurality of appliances belong to a particular appliance category.

14. A method according to claim 1, comprising dynamically determining the appliance categories.

15. A method according to claim 1, in which said outputting comprises annunciating an indication of the calculated current total level of usage of the utility for the at least one of the plurality of appliance categories.

16. A method according to claim 1, in which said obtaining comprises:
measuring the current total use of the utility by the plurality of appliances to obtain utility usage values; and
analysing the utility usage values to identify which of the plurality of appliances is using the utility and to calculate the current level of usage of the utility by an identified appliance.

17. A system comprising:
a processor arranged to:
obtain data indicating, for each of a plurality of appliances, a respective current level of usage of the utility by that appliance; and
for each of a plurality of appliance categories, use the obtained data to calculate a respective current total level of usage of the utility by appliances belonging to that appliance category; and
an interface arranged to output an indication of the calculated current total level of usage of the utility for at least one of the plurality of appliance categories.

18. A system according to claim 17, comprising an input arranged to allow a user to select an appliance category from the plurality of appliance categories, wherein said interface is arranged to output an indication of the calculated current total level of usage of the utility for the selected appliance category.

19. A system according to claim 17, wherein the processor is arranged to use the obtained data to calculate a current total level of usage of the utility by the plurality of appliances; and wherein the interface is arranged to output an indication of the calculated current total level of usage of the utility by the plurality of appliances.

20. A system according to claim 17, wherein said interface comprises a display for displaying an indication of the calculated current total level of usage of the utility for the at least one of the plurality of appliance categories.

21. A system according to claim 20, wherein said interface is arranged, for each appliance category, to display an associated icon to represent the appliance category, and to set a colour of an icon to indicate the calculated current total level of usage of the utility for the appliance category associated with that icon.

22. A system according to claim 21, wherein said interface is arranged to set a colour of an icon by selecting a colour for the icon from a predetermined set of colours, wherein each colour in the predetermined set of colours represents an associated range of levels of usage of the utility.

23. A system according to claim 22 wherein said interface is arranged, for at least one of the colours in the predetermined set of colours, to adjust the associated range of levels of usage of the utility based on an input from the user.

24. A system according to claim 20 wherein said interface is arranged to indicate, on a scale with colour-coding, the calculated current total level of usage of the utility for the at least one of the plurality of appliance categories.

25. A system according to claim 24 wherein said interface is arranged to adjust the colour-coding of the scale based on an input from the user.

26. A system according to claim 20 wherein said interface is arranged to display a numerical value indicating the calculated current total level of usage of the utility for the at least one of the plurality of appliance categories.

27. A system according to claim 17, wherein the processor is arranged to use the obtained data to calculate a level of usage of the utility by the plurality of appliances over a period of time, and wherein the interface is arranged to output an indication of the calculated level of usage of the utility by the plurality of appliances over the period of time.

28. A system according to claim 17, wherein, for at least one of the plurality of appliance categories, the processor is arranged to use the obtained data to calculate a level of usage of the utility by appliances belonging to that appliance category over a period of time, and wherein the interface is arranged to output an indication of the calculated level of usage of the utility by appliances belonging to that appliance category over the period of time.

29. A system according to claim 17, wherein the system is arranged to allow a user to specify which of the plurality of appliances belong to a particular appliance category.

30. A system according to claim 17, wherein the processor is arranged to dynamically determine the appliance categories.

31. A system according to claim 17, in which said interface is arranged to annunciate an indication of the calculated current total level of usage of the utility for the at least one of the plurality of appliance categories.

32. A system according to claim 17, in which said system is arranged to:
measure the current total use of the utility by the plurality of appliances to obtain utility usage values; and
analyse the utility usage values to identify which of the plurality of appliances is using the utility and to calculate the current level of usage of the utility by an identified appliance.

33. A system according to claim 17, in which said interface is arranged to output said indication of the calculated current total level of usage of the utility for at least one of the plurality of appliance categories to a user terminal.

34. A user interface arranged to output to a user an indication of a current total level of usage of a utility by a subset of appliances from a plurality of appliances.

35. A computer readable medium storing a computer program which, when executed by a processor, carries out the steps of:
obtaining data indicating, for each of a plurality of appliances, a respective current level of usage of the utility by that appliance;
for each of a plurality of appliance categories, using the obtained data to calculate a respective current total level of usage of the utility by appliances belonging to that appliance category; and
outputting an indication of the calculated current total level of usage of the utility for at least one of the plurality of appliance categories.

36. A method of non-intrusive utility monitoring for monitoring the use of at least one utility supplied to a plurality of appliances, the method comprising:
receiving utility values representative of the total use of the at least one utility by the plurality of appliances;
analysing the received utility values using a plurality of analysis modules, wherein each analysis module corresponds to a respective predetermined type of utility usage, and wherein each analysis module is arranged to calculate, based on the received utility values, a respective confidence value indicative of a confidence that the respective predetermined type of utility usage has occurred; and
performing a fuzzy logic analysis of the calculated confidence values so as to identify the operation of an appliance.

37. The method of claim 36 wherein the predetermined type of utility usage for one of the plurality of analysis modules is usage representative of a resistive device with a relatively constant steady-state load.

38. The method of claim 36 wherein the predetermined type of utility usage for one of the plurality of analysis modules is usage representative of a predominantly resistive device employing intra-cycle switching to variably control the power supplied to a load.

39. The method of claim 36 wherein the predetermined type of utility usage for one of the plurality of analysis modules is usage representative of an induction motor wherein a path traced by real power values against corresponding reactive power values over a time period of interest comprises one or more substantially circular arcs.

40. The method of claim 36 wherein the at least one utility comprises electricity, and the utility values comprise values representative of the electrical current and/or the electrical voltage supplied to the plurality of appliances.

41. The method of claim 36 wherein the at least one utility comprises one or more of water, gas and oil.

42. The method of claim 36 further comprising detecting at least one utility event based on the received utility values.

43. The method of claim 36 wherein each confidence value is a degree of membership of a respective membership function corresponding to the respective predetermined type of utility usage.

44. A computer readable medium storing a computer program which, when executed by a processor, carries out a method of non-intrusive utility monitoring for monitoring the use of at least one utility supplied to a plurality of appliances by carrying out the steps of:
receiving utility values representative of the total use of the at least one utility by the plurality of appliances;
analysing the received utility values using a plurality of analysis modules, wherein each analysis module corresponds to a respective predetermined type of utility usage, and wherein each analysis module is arranged to calculate, based on the received utility values, a respective confidence value indicative of a confidence that the respective predetermined type of utility usage has occurred; and
performing a fuzzy logic analysis of the calculated confidence values so as to identify the operation of an appliance.

45. A non-intrusive utility monitoring apparatus for monitoring the use of at least one utility supplied to a plurality of appliances, the apparatus comprising:
an input section arranged to receive utility values representative of the total use of the at least one utility by the plurality of appliances;
a plurality of analysis modules, wherein each analysis module corresponds to a respective type of utility usage, and wherein each analysis module is arranged to analyse the received utility values so as to calculate, based on the received utility values, a respective confidence value indicative of a confidence that the respective type of utility usage has occurred; and
a fuzzy logic module arranged to perform a fuzzy logic analysis of the calculated confidence values so as to identify the operation of an appliance.

46. The apparatus of claim 45 further comprising a processor which comprises the plurality of analysis modules and the fuzzy logic module.
